(19) United States
(12) Patent Application Publication
(10) Pub. No.: US 2002/0022415 A1
(43) Pub. Date: Feb. 21, 2002

(54) Method and device for providing improved additional buoyance and water speed to amphibious vehicle

(76) Inventors: Youn Sang Choi, Taejon (KR); Woo II Lee, Seoul (KR)

Correspondence Address: DOUGHERTY & TROXELL, 5205 LEESBURG PIKE, SUITE 1404, FALLS CHURCH, VA, 22041, US

(21) Appl. No.: 09/920,819

(22) Filed: Aug. 3, 2001

(30) Foreign Application Priority Data
Aug. 10, 2000 (KR) 2000-46444
May 7, 2001 (KR) 2001-24693

(51) Int. Cl. B60F 3/00; B63H 1/00; B63H 19/08

(52) U.S. Cl. 440/12.5

(57) ABSTRACT

Disclosed is a folding floatation device that is folded at the time when an amphibious vehicle is driven on the water, thereby providing improved safety and increased driving speed to the amphibious vehicle and a method for providing additional buoyance to the amphibious vehicle at the time of driving on the water by using the folding floatation device. According to the present invention, there are provided a folding floatation device with the lower portion opened, a folding flotation device with the upper portion opened and a closed folding flotation device, each of which is disposed at an appropriate location of the vehicle body, such that each floatation device is folded during driving on land and unfolded only during driving on the water, thereby providing additional buoyance to the amphibious vehicle. Therefore, the floatation device of the present invention can provide improved performance to existing amphibious vehicles and overcome design limitations on the driving on the water in case where a novel model is developed, thereby providing a high performance vehicle. With a method for embodying the folding floatation device with the lower portion opened in a space of a suspension device, more particularly, a water driving speed in a track driving manner can be enhanced over that in a water jet driving manner.

### BACKGROUND OF THE INVENTION

1. Field of the Invention

The present invention relates to a method for providing additional buoyance to an amphibious vehicle and a novel floatation device used according to the method, and more particularly, to a method for providing improved additional buoyance and water speed to an amphibious vehicle, by using a folding floatation device that is folded when the amphibious vehicle is driven on land and unfolded when it is driven on the water to provide the additional buoyance to the amphibious vehicle, thereby ensuring the safety of the amphibious vehicle at the time of driving on the water and the increment at the driving speed, which results in the improvement in the driving performance of the amphibious vehicle on the water.

2. Background of the Related Art

A conventionally proposed amphibious vehicle is designed in such a manner that a substantially large space is provided in the interior of a vehicle body and the total weight of the vehicle is lighter than weight (that is, an amount of displacement) allowing the vehicle to be fully submerged in the water, such that it can float on the water by the buoyance of water. If the amphibious vehicle receives persons or equipment at maximum load weight, it is submerged in the water approximately over 80%.

However, if the amphibious vehicle is provided with an thick armor plate for the purpose of enhancing its protection capability, or since the amphibious vehicle is provided with some heavy mounting equipment such as heavy firearms, if the weight of the vehicle exceeds the buoyance, there is no expectation for good water driving capability of the amphibious vehicle even at its developing step. If this kind of amphibious vehicle goes across a river, a floating bridge should be disposed, which makes its combat strength undesirably low.

On the other hand, the amphibious vehicle can obtain its driving force on the water by using a track rotation method and a water jet driving method.

According to the track rotation method, an endless track of a suspension device rotates to push water such that the amphibious vehicle obtains its driving force. This does not need any separate driving device, so it is convenient and economical, but there is a disadvantage that the amphibious vehicle moves very slow.

FIG. 1 illustrates a conventional amphibious vehicle 1, where, as well known, a hanging 4 mounted on the outside of a suspension device 2 is adapted to make the flow of water good when the amphibious vehicle 1 is driven on the water, thereby improving the driving speed of the amphibious vehicle 1. And, an endless track 3 is exposed on its front and rear portions in order for the amphibious vehicle 1 to be driven on land in a convenient manner. A reference numeral 6 denotes a water blocking plate that is adapted to be unfolded toward its front direction when the amphibious vehicle 1 is driven on the water, thereby preventing the upper portion of the amphibious vehicle 1 from overflowing with the water.

An explanation of the generation of the driving force of the amphibious vehicle 1 according to the track rotation method will be in more detail described. If the track rotates in the water, the lower track pushes water back to generate the driving force, but at this time, the upper track moves in a reverse direction, which results in the generation of a reverse driving force. However, the direction of the flow of water is turned under the configuration of the amphibious vehicle surrounding the upper track, such that the reverse driving force is considerably decreased, and a difference of water pressure between the upper and lower track positions enables the driving force to be stronger than the reverse driving force. But the driving force obtained by the track rotation method is not enough and the power efficiency thereby is very bad.

According to the water jet driving method, on the other hand, a flow tube is disposed in the interior of the vehicle body and a pump is installed within the flow tube. If the pump operates, water flows in the flow tube and then, the water within the flow tube is discharged to the outside, thereby obtaining the driving force of the amphibious vehicle. This method ensures a relatively fast water driving speed, but the water jet equipment is very expensive and additionally disposed in the interior of the vehicle body specially, such that there occur some disadvantages that the internal space of the vehicle body is decreased and the weight of the vehicle body is increased.

In addition, the amphibious vehicle 1 does not take a streamline shape unlike a general ship, such that it has considerable water resistance in view of the characteristic of its structure. Therefore, the amphibious vehicle adopting the track rotation method is driven on the water at a velocity of 6 km to 7 km an hour and even though the water jet driving method is adopted, it is driven on the water at a velocity of 10 km to 12 km an hour.

### SUMMARY OF THE INVENTION

Accordingly, the present invention is directed to method and device for providing improved additional buoyance and water speed to an amphibious vehicle that substantially obviates one or more problems due to limitations and disadvantages of the related art.

An object of the present invention is to provide method and device for providing improved additional buoyance and an increased water driving speed to an amphibious vehicle when the amphibious vehicle is driven on the water, thereby ensuring a high combat strength of the amphibious vehicle.

Another object of the present invention is to provide method and device for rendering buoyance of an amphibious vehicle desirably optimized to thereby reduce the volume of the amphibious vehicle submerged in the water, whereby the amphibious vehicle has relatively low resistance against water when driven on the water.

Still another object of the present invention is to provide method and device for providing improved additional buoyance to an amphibious vehicle when the amphibious vehicle is driven on the water, thereby making it possible to mount additional combat equipment on the amphibious vehicle, which will result in a high combat strength of the amphibious vehicle.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there are provided a folding floatation device with the lower portion opened, a folding floatation device with the upper portion opened, a closed folding floatation device, and a method for providing improved additional buoyance to an amphibious vehicle by using such floatation devices.

With the floatation device configured in a relatively simple manner according to the present invention, the buoyance of the amphibious vehicle at the time of water driving can be remarkably increased.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a perspective view illustrating a conventional amphibious vehicle;

FIG. 2 is a perspective view illustrating a folding floatation device with the lower portion opened that is attached on an amphibious vehicle and thus folded according to a first embodiment of the present invention;

FIG. 3 is a perspective view illustrating the folding floatation device with the lower portion opened that is attached on the amphibious vehicle and thus unfolded according to the first embodiment of the present invention;

FIG. 4 is a perspective view illustrating a folding floatation device with the lower portion opened that is attached on an amphibious vehicle and thus folded according to a second embodiment of the present invention;

FIG. 5 is a perspective view illustrating the folding floatation device with the lower portion opened that is attached on the amphibious vehicle and thus unfolded according to the second embodiment of the present invention;

FIG. 6 is a graph illustrating the variation of the driving speed according to the variation of the driving force and water resistant force of the amphibious vehicle;

FIG. 7 is a rear view illustrating a folding Floatation device with the upper portion opened that is attached on the rear side of an amphibious vehicle and thus folded according to a third embodiment of the present invention;

FIG. 8 is a rear view illustrating the folding floatation device with the upper portion opened that is attached on the rear side of the amphibious vehicle and thus unfolded according to the third embodiment of the present invention;

FIG. 9 is a perspective view illustrating a closed folding floatation device that is attached on the side of an amphibious vehicle and thus folded according to a fourth embodiment of the present invention;

FIG. 10 is a perspective view illustrating the closed folding floatation device that is attached on the water blocking plate of the amphibious vehicle and thus folded according to the fourth embodiment of the present invention;

FIG. 11 is an exemplary view illustrating an internal configuration of the closed folding floatation device according to the fourth embodiment of the present invention; and

FIG. 12 is a plan view illustrating a partitioned internal configuration of the closed folding floatation device according to the fourth embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

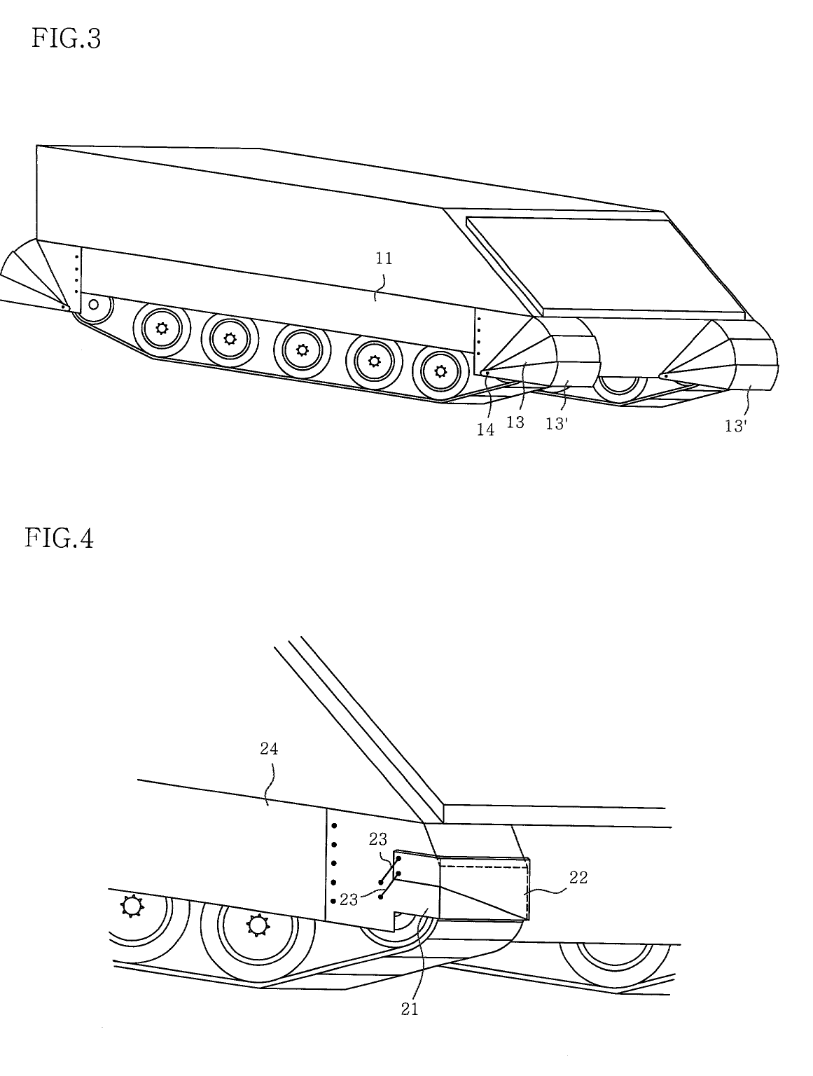

FIG. 2 is a perspective view illustrating a folding floatation device 10 with the lower portion opened that is attached on an amphibious vehicle and thus folded according to a first embodiment of the present invention and FIG. 3 is a perspective view illustrating the folding floatation device with the lower portion opened that is attached on the amphibious vehicle and thus unfolded according to the first embodiment of the present invention.

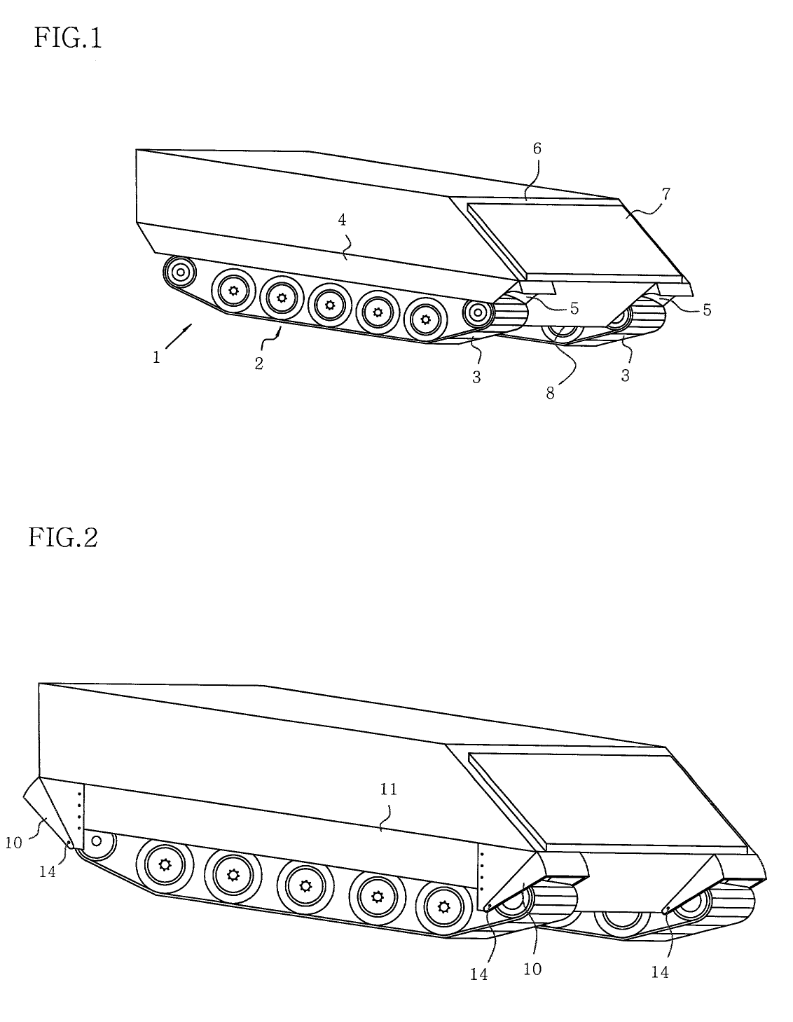

As shown in FIGS. 2 and 3, the amphibious vehicle 1 with a folding floatation device 10 opened at the lower portion thereof (hereinafter, referred to as “floatation device 10”) according to the present invention is provided with a hanging 11 extended downward in a relatively long length than the hanging 4 (see FIG. 1) attached on the conventional amphibious vehicle but disposed in such a manner as to be somewhat higher than a bottom surface 8 of the vehicle body of the amphibious vehicle.

On the other hand, on the respective front and rear sides where a track 3 of the amphibious vehicle runs there is provided a track exposing part (that is, an opening) 5 for making the activity of the amphibious vehicle 1 smooth, and in this case, the floatation device 10 according to the present invention is installed on the above-mentioned track exposing part 5. The flotation device 10 of the present invention is in a folded state as shown in FIG. 2, when the amphibious vehicle 10 is driven on land and in an unfolded state as shown in FIG. 3, when the amphibious vehicle 10 is driven on the water. At this time, when the amphibious vehicle 10 is in the folded state as shown in FIG. 2, the floatation device 10 allows the track 3 to be sufficiently exposed, such that the amphibious vehicle 1 can be smoothly driven on land, without any interruption.

The floatation device 10 of the present invention is configured in such a manner that two or more folded plate frames 13 are coupled by a coupling member 14 with a hinge function and thus unfolded or folded, if necessary. The unfolding or folding of the floatation device 10 is carried out by means of an oil cylinder or other means.

Between the plate frames 13 there is provided a waterproof fabric that is not shown in the drawing, such that the unfolding and folding of the plate frames 13 can be freely carried out and tightness against water can be obtained. At this time, if the waterproof fabric is adapted to connect the bottom end of the upper plate frame with the intermediate portion of the lower plate frame, the plate frames 13 can have the limited movement range when folded or unfolded and the waterproof fabric can be reduced to a minimum size. In order to obtain the tightness against water, there is provided a stop structure that is not further unfolded like an antenna drawn at the time when the plate frames 13 are unfolded to the maximum length thereof, in which a seal pad is provided.

The back side opened of the floatation device 10 is rigidly attached on the track exposing part 5 on the front and rear sides of the amphibious vehicle 1, respectively by using a welding method, and the frontmost plate frame 13′ is coupled with an appropriate operating device such as an oil cylinder. In this case, the operating device may be located at an arbitrary position where the floatation device 10 can be convenient to operate. The function of the operating device can be replaced in a manually operating manner, and at this time, there is a need for installation of a fixing device for maintaining the folded or unfolded state.

If the floatation device 10 attached is unfolded (see FIG. 3), a closed space (hereinafter, referred to as “buoyance space”), which is closed by the other sides except the bottom side, is formed between the lower portion of the body of the amphibious vehicle 1 and the upper portion of the upper portion of the track 3. At this time, the side hanging 11 is disposed in such a manner as to be somewhat higher than the bottom side of the unfolded floatation device 10. This is to improve the safety in a rolling direction as will be in detail discussed later.

The amphibious vehicle 1 with the floatation device 10 attached is provided with an air pumping device (or a plurality of air pumping devices) (which is omitted in the drawing) for supplying air absorbed from the atmosphere to the buoyance space. The air pumping device(s) is comprised of an air absorbing hole, an air exhausting hole, a switch valve, a pump and a control system. The air pumping device(s) is well known, and therefore, an explanation of it will be excluded in this detailed description for the sake of brevity.

As shown in FIG. 2, while the amphibious vehicle 1 is driven on land in the state where the floatation device 10 is folded if it is to be driven on the water to go across a rivers the floatation device 10 is unfolded such that the buoyance space is formed. And, air is supplied by using the air pumping device to the buoyance space, with a consequence that the buoyance space is filled with the air.

The amphibious vehicle is designed in such a manner as to be floated on a predetermined portion thereof even if it does not have any floatation device according to the present invention, but if it is provided with the floatation device 10 of the present invention, it can additionally obtain the buoyance corresponding to the water weight having the same volume as the air volume by virtue of the air in the interior of the buoyance space. During the amphibious vehicle 1 is driven on the water if an appropriate amount of air is continuously supplied to the interior of the buoyance space by means of the air pumping device, the air that is exhausted due to the movement of the vehicle body or the surface of water can be immediately filled up, with a result that the air layer in the buoyance space is constant and stable.

As discussed above, with the floatation device of the present invention configured in a relatively simple manner, the buoyance of the amphibious vehicle upon driving on the water can be greatly increased. In addition, the height of the hanging 11 is designed to be somewhat higher than the bottom end of the floatation device at the time when the floatation device is unfolded, and the buoyance space is inclinedly formed by connecting the edge at the vehicle body side to the end of the hanging, such that when the amphibious vehicle is inclined left or right during driving on the water, the volume of the buoyance space at the inclined side is expanded by the surface of water insisting on having a horizontal surface and also the buoyance space expanded is immediately filled with air or gas supplied continuously, thereby resulting in the increment of the buoyance by the space really expanded. To the contrary, the buoyance space lifted upward is decreased by the same principle as mentioned above, such that surplus air is exhausted to the outside of the buoyance space and thus, the volume of buoyance is more decreased than that in the horizontal state. Therefore, a force for lifting the buoyance space upward acts on the buoyance space inclined and a force for pushing the buoyance space downward relative to the horizontal state of the surface of water, that is, a force for restoring the surface of water to its original horizontal state, acts on the buoyance space lifted upward, thereby ensuring safety on driving all the time.

However, in case where the safety in the rolling direction is sufficient thereby making the additional buoyance not important or in case where the additional buoyance is more important, there is no need to render the buoyance space configured inclinedly, and if the folding floatation device at the front and rear portions of the amphibious vehicle with the side hanging is unfolded to the bottom surface of the vehicle body, the additional buoyance can be optimized.

If the air is maintained in the buoyance space formed on the position of the suspension device of the amphibious vehicle, the upper track of the amphibious vehicle is exposed in the air, with a consequence that the reverse driving force produced on the upper portion of the track 3 disappears. That is to say, if the upper portion of the track 3 of the amphibious vehicle is located in the air of the buoyance space, the reverse driving force caused during the rotation of the upper portion of the track 3 in the water completely disappears, such that a forward driving force of the amphibious vehicle (i.e., a difference between the driving force caused from the lower portion of the track 3 and the reverse driving force caused from the upper portion of the track 3) is greatly increased. In addition, the power consumed in order for the upper portion of the track 3 to push the water is saved, thereby creating a high power efficiency, and if the increased power efficiency is used for the purpose of increasing the rotation speed of the track, the driving force of the amphibious vehicle is considerably improved, which results in a remarkably high driving speed on the water of the amphibious vehicle.

If only the improvement at the driving speed according to the track driving method is desired, all devices and methods for rendering the upper track move in the air during the water driving, in addition to the folding floatation device with the lower portion opened and the method using the same, can be employed By way of example, the upper portion of the track is surrounded with a predetermined housing, in which the buoyance space is formed, and if the air is supplied in the buoyance space, the upper track moves in the air, thereby accomplishing the improvement at the driving speed.

In case where the suspension device is closed with a predetermined housing to form the air buoyance space, it is desirable that the housing is not descended under the center height of a driving tooth wheel (sprocket) for the purpose of obtaining mobility on land such as capability for overcoming vertical obstacles.

FIGS. 4 and 5 show a folding floatation device 20 with the lower portion opened according to a second embodiment of the present invention adopting such the housing. The height of the housing 21 on the front portion of the track is relatively high by the reason as discussed in the above, but the side hanging 24 is disposed somewhat low. And, there is provided a tight plate structure 22 with a double rotary arm 23 on the front portion of the front housing 21, which is ascended upward during driving on land and descended downward during driving on the water, such that it is tightly contacted with the front housing 21 and the side hanging 24, thereby resulting in the formation of the buoyance space. The tight plate structure 22 can be moved and fixed to the upper position and the lower position by means of an appropriate operating device or manually in the same manner as in the first embodiment of the present invention. When the tight plate structure 22 is descended downward to thereby form the buoyance space expanded, the tightness against water can be obtained if a seal pad made of a substantially elastic material is attached on the portion thereof contacted with the housing. FIG. 4 illustrates only the front housing 21, but of course, the rear housing has the same structure as the front housing 21.

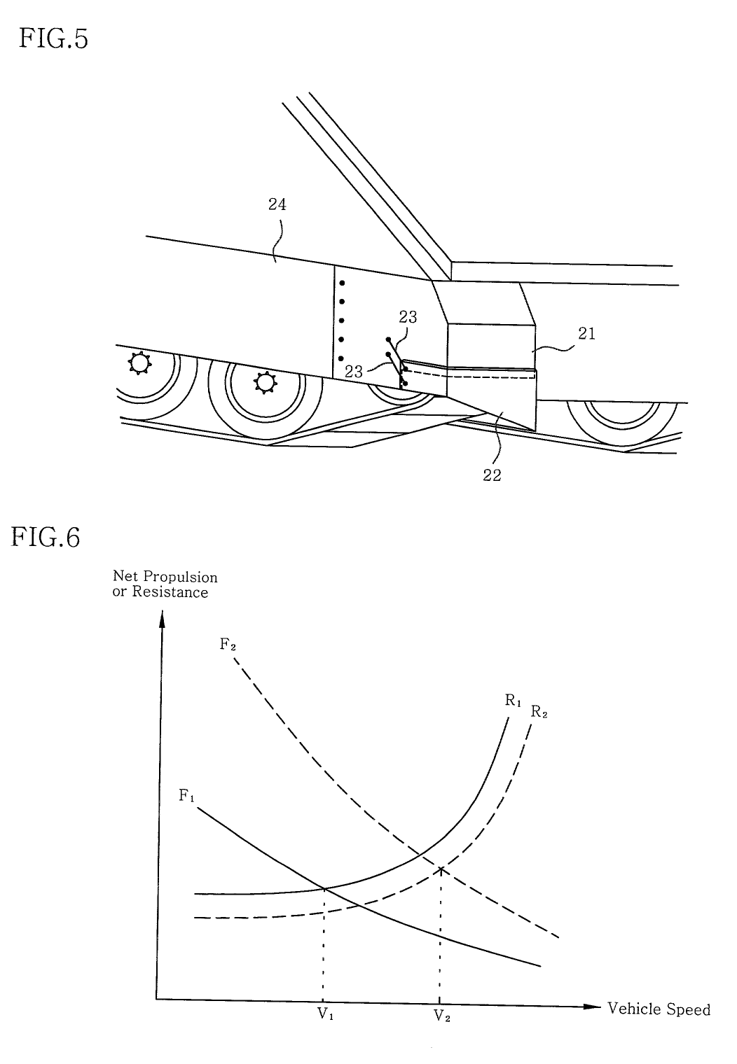

FIG. 6 is a graph illustrating the variation of the driving speed according to the variation of the driving force and water resistant force between the conventional amphibious vehicle and the amphibious vehicle with the floatation device attached according to the present invention, wherein a graph F₁ shows the driving force of the conventional amphibious vehicle and a graph R₁ shows the resistant force against water of the conventional amphibious vehicle. An intersection V₁ between the two graphs F₁ and R₁ represents the resulting driving speed of the conventional amphibious vehicle.

The amphibious vehicle with the floatation device attached according to the present invention exhibits characteristics that the forward driving force is greatly increased and the resistance force against water is reduced in correspondence with the rate of the buoyance increased, such that the forward driving force is obtained as illustrated in a graph F₂ and the resistance force against water is obtained as illustrated in a graph R₂. Therefore, the driving speed obtained as an intersection V₂ between the two graphs F₂ and R₂ is greatly increased when compared with the driving speed V₁ of the conventional amphibious vehicle.

When the buoyance space is formed in the lower portion of the vehicle body, there occur some advantages such as the buoyance increase, the driving speed improvement and the safety in the rolling direction, whereas there occurs a disadvantage that the restoring force in a direction of pitch is somewhat reduced due to a free surface of water effect of the buoyance space. However, since the restoring force in the direction of pitch is greatly stronger than that in the rolling direction by the rectangular form of the amphibious vehicle, the reduction in the restoring force in the direction of pitch is not really important. The reduction in the restoring force can be offset by the increase of a freeboard according to the buoyance increment, which doesn't give any influence to the safety. Furthermore, in case where various kinds of floatation devices according to the present invention as will be discussed later are at the same time employed, the restoring forces in the directions of pitch and rolling are greatly increased, thereby improving the safety.

In case where the folding floatation device with the lower portion opened that is employed in the space of the suspension device is changed to have the size and shape corresponding to the position where it is employed, that is, to have a similar structure to the folding floatation device with the upper portion opened as will be discussed hereinafter and applied on the side or rear portion of the vehicle body, the additional buoyance can be obtained and in this case, the basic principle of the folding floatation device with the lower portion opened is the same as the folding floatation device with the upper portion opened, an explanation of which will be excluded.

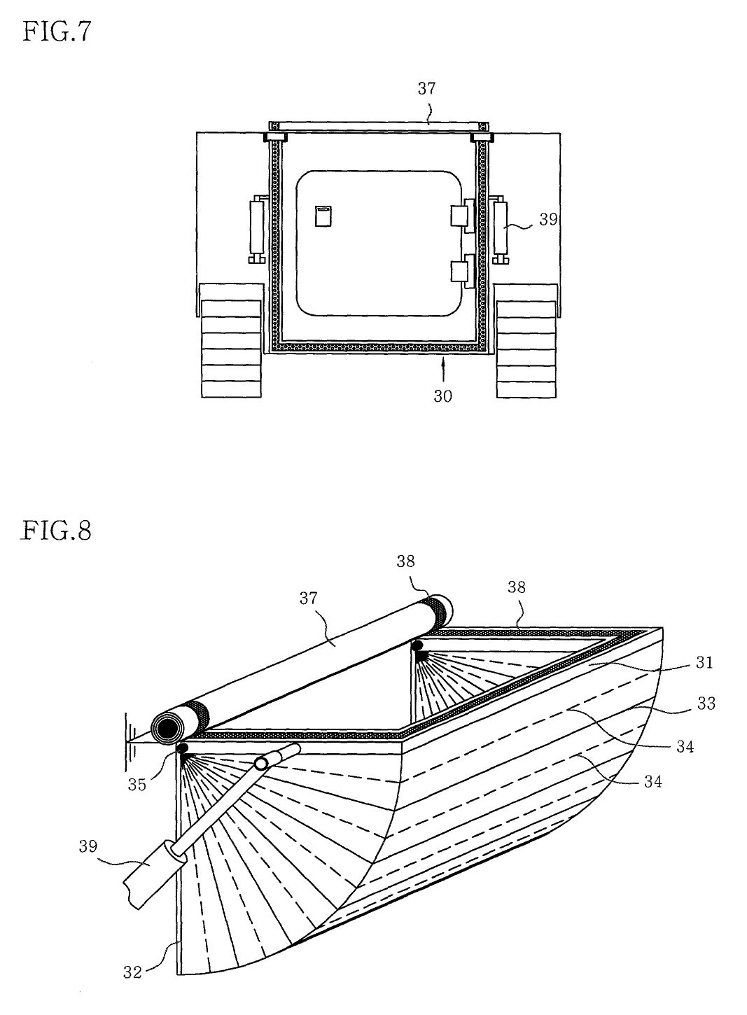

FIGS. 7 and 8 show the folding floatation device 30 with the upper portion opened according to a third embodiment of the present invention.

The folding floatation device 10 with the lower portion opened according to the first embodiment of the present invention is opened at the lower portion thereof, and to the contrary, the folding floatation device 30 with the upper portion opened according to the third embodiment of the present invention is opened at the upper portion thereof and applied on the rear portion of the amphibious vehicle 1. Under the above configuration, the volume of the amphibious vehicle 1 to which the buoyance of water is applied is increased and contrarily, the weight thereof is not almost increased, such that a substantially high buoyance is applied to the amphibious vehicle 1.

Now, an explanation of the configuration of the folding floatation device 30 with the upper portion opened according to the third embodiment of the present invention will be in detail described.

The folding floatation device 30 with the upper portion opened is configured in such a manner that a plurality of frames 33 is hinge-coupled between a fixing frame 32 fixed on the vehicle body and an outermost frame 31 by means of a coupling member 35, each of the plurality of frames being provided with an outer cover 36 thereon. In addition, an elastic member 34 is attached between the fixed frame 32 and the frame 33, between the plurality of frames 33 and between the frame 33 and the outermost frame 31 on the outer cover 36, for the purpose of providing tension to them, such that when the floatation device 30 is folded, it can be folded regularly in a predetermined form. The unfolding and folding operations of the floatation device are carried out in a rotation-developing manner as the coupling member 35 has a hinge function, that is, by virtue of an oil cylinder 39 that is attached on the vehicle body at one end thereof and attached on the outermost frame 31 at the other end thereof or appropriate means.

When the folding floatation device 30 with the upper portion opened is folded, the plurality of frames 33, the elastic members 34 and the outer cover 36 are in orderly form folded and disposed in a space between the fixed frame 32 and the outermost frame 31. In order to form the space, the fixed frame 32 and the outermost frame 31 exactly match with each other and have a section of “ [symbol] ” to form the space therebetween. Specifically, a door is installed on the rear side of the amphibious vehicle, but in the state where the folding floatation device 30 with the upper portion opened is folded, the door can be freely used without any inconvenience.

Since the buoyance space formed by the floatation device 30 according to the third embodiment of the present invention is exposed in the air, there is an advantage that pouring air to the buoyance space by using an air pumping device is not needed, whereas there is a disadvantage that the buoyance space is overflown with water during the amphibious vehicle is driven on the water, thereby somewhat reducing the buoyance the amphibious vehicle has.

To remove the above-mentioned disadvantage, however, the flotation device 30 is provided with a fabric cover 37 that is attached on the top portion of the rear portion of the vehicle body at the one end thereof and is attached on a bar at the other end thereof. The fabric cover 37 is rolled and when unrolled, it can cover the opened part of the floatation device. That is, the fabric cover 37, which is attached on the vehicle body at the one end thereof and rolled in normal case on the bar at the other end thereof, is unrolled to be fixed on a Velcro band 38 attached on the outermost frame 32 of the floatation device 30 to thus cover the opened part, thereby preventing flowing of water in the buoyance space.

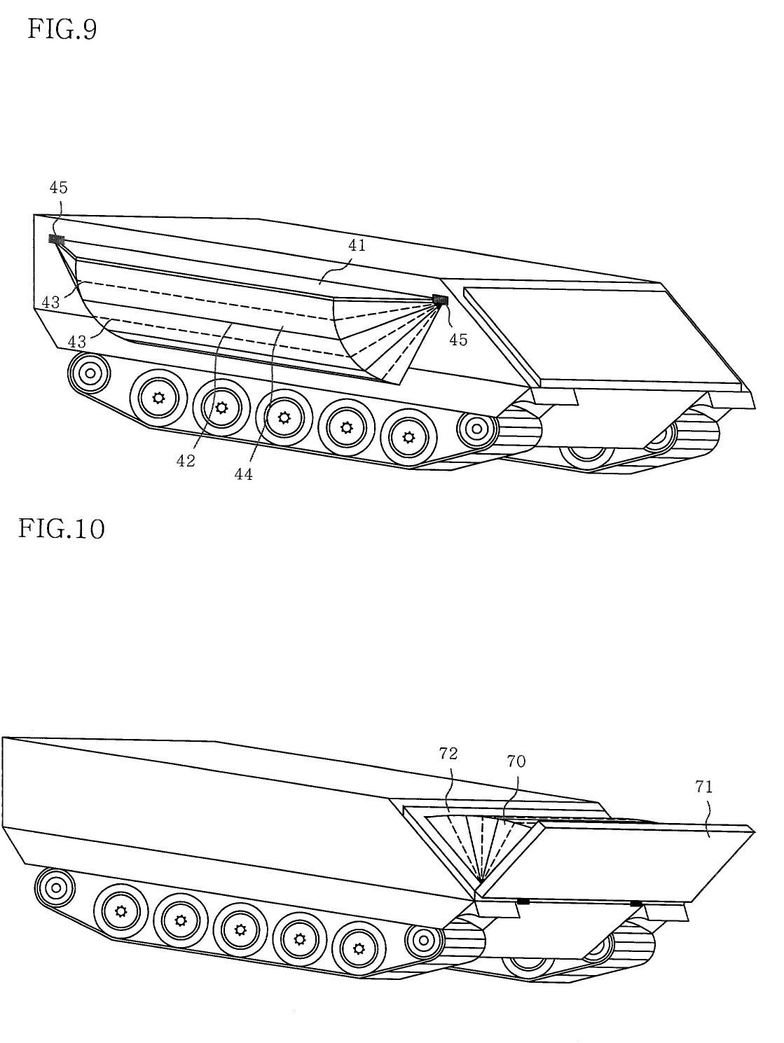

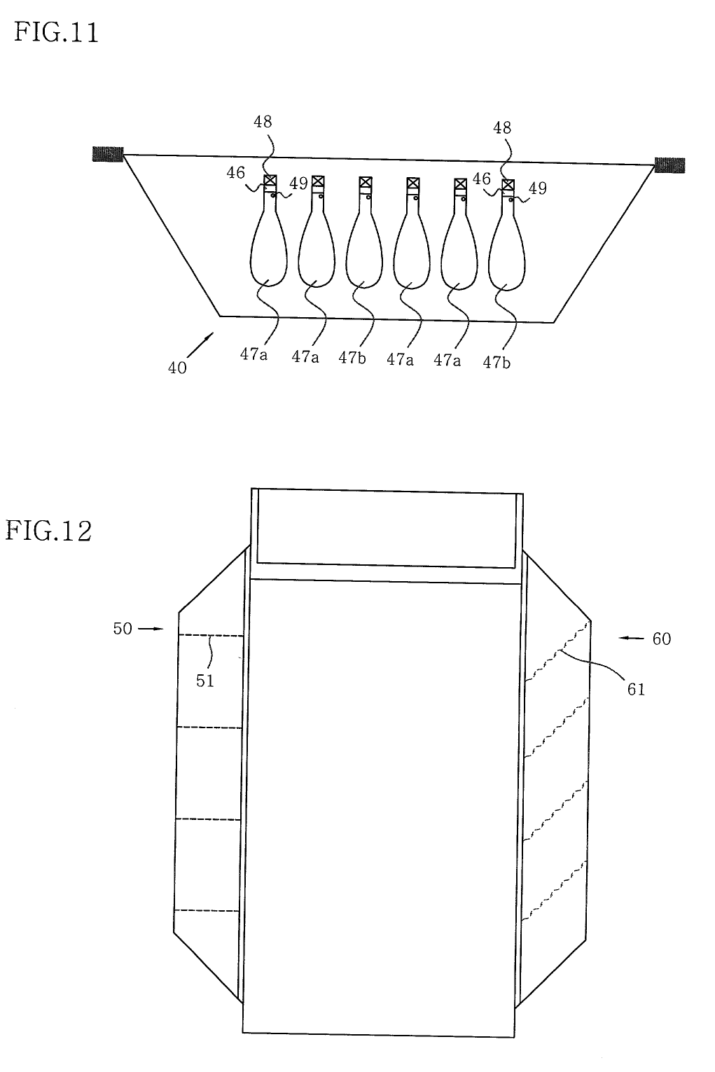

FIG. 9 shows the external appearance of the closed folding floatation device 40 according to a fourth embodiment of the present invention and FIG. 11 shows the internal configuration of the closed folding floatation device 40.

The closed folding floatation device 40 according to the fourth embodiment of the present invention is configured in such a manner that it is similar to the folding floatation device 30 with the upper portion opened, but it is provided with an outer plate 41 replacing the outermost frame 31, it is relatively extended in length because attached on the side of the vehicle body and it forms a closed space when the floatation device 40 is unfolded by 90°, whereby it is completely closed in order not to flow water to the interior of the buoyance space when the amphibious vehicle 1 is driven on the water. The frame 42, the outer cover 44, the elastic member 43 and the coupling member 45 of the closed folding flotation device 40 are almost same as in the third embodiment of the present invention. Since the flotation device 40 can be unfolded or folded by means of an oil cylinder or other appropriate means, the amphibious vehicle is driven on land in the state where the floatation device 40 is folded and driven on the water in the state where the floatation device 40 is unfolded. The angle at which the floatation device 40 is unfolded or the direction upward and downward to which the floatation device 40 is unfolded is differently determined upon the structure the portion of the amphibious vehicle on which the flotation device 40 is attached has.

The closed folding floatation device 40 exhibits a considerably poor function as the floatation device in case where the outer cover is broken by shots fired from an enemy force during combat. To avoid such the problem, the present invention adopts such an internal configuration as shown in FIG. 11

As shown, the floatation device 40 according to the fourth embodiment of the present invention is provided with a plurality of balloons 47a and 47b. And, gas is poured to each of the plurality of balloons 47a and 47b by means of an air pouring hole 46 and a control valve 48. Further, a pressure sensor 49 is attached on each balloon, for checking the expansion state of the corresponding balloon. The control valve 48 and the pressure sensor 49 are connected to the main control chamber of the amphibious vehicle and automatically controlled by a computer or controlled automatically.

The plurality of balloons 47a and 47b are divided into the balloons 47a actually used at the time of driving on the water and the balloons 47b used at an emergency state. An allowable expansion volume of each balloon is greatly larger than the expansion volume of the outer cover of the floatation device 40 (for example, two times or more), and each balloon is made of a special rubber material having very strong elasticity and high tension strength unlike a general balloon.

If the amphibious vehicle 1 with the closed folding floatation device 40 is to be driven on the water, the floatation device 40 is first unfolded by using the oil cylinder and the gas is poured to the balloons 47a by means of the respective air pouring holes 46, thereby making the balloons 47a expanded. At this time, the floatation device 40 can be unfolded to its maximum expansion volume as the balloons 47a are expanded, thereby providing additional buoyance to the amphibious vehicle 1. At this time, of course, the gas is not poured to the spare balloons 47b.

If some balloons 47a are broken due to the shots from the enemy force or other causes while the amphibious vehicle 1 is being driven on the water, the remaining balloons 47a are continuously expanded, thereby providing the same buoyance as in an initial state. As discussed above, since the total allowable expansion volume of the plurality of balloons 47a is over the maximum expansion volume of the floatation device 40 (for example, two times or more), the remaining balloons 47a are expanded large in case where one of the balloons 47a is broken to reduce the total volume of the balloons 47a, whereby the whole volume of the floatation device can be kept similarly to its initial volume.

The balloons 47a are always expanded by the whole volume of the floatation device 40, and therefore, even though the outer cover of the floatation device 40 is broken by the shots fired by the enemy force, pouring of water to the interior of the floatation device 40 through the broken holes can be minimized.

If half or more the balloons 47a are broken to thereby cause the total expansion volume of the balloons 47a to be smaller than the maximum expansion volume of the floatation device 40, the computer connected to the pressure sensor immediately recognizes the contents and commands the spare balloons 47b to carry out gas pouring, such that the spare balloons 47b are expanded to restore the buoyance of the amphibious vehicle to its original state.

According to the fourth embodiment of the present invention, the number of balloons 47a and the number of spare balloons 47b to be provided with the floatation device 40 may be determined arbitrarily upon the kind and size of the amphibious vehicle. In some cases, the use balloons 47a and the spare balloons 47b are adjacent to each other in relation with 1:1 and whenever one is broken, the gas may be poured into the spare balloon adjacent thereto.

Another structure of the closed folding floatation device 40 capable of providing safety against the shots fired is made by partitioning the buoyance space of the floatation device 40. FIG. 12 shows a plan view of the amphibious vehicle, where a simply partitioned closed flotation device 50 as illustrated left may cause a problem that a plurality of bulkheads 51 are simultaneously broken by a shot fired toward the front side of the amphibious vehicle by the enemy force. Contrarily, a functionally partitioned closed floatation device 60 according to the present invention is provided with a plurality of inclined folding bulkheads 61 that have the angle slant to the front surface of the amphibious vehicle, thereby reducing the number of bulkheads 61 that may be broken at the same time. In order to make up for the buoyance lost at the time when one partitioned chamber is broken, each of the plurality of bulkheads 61 has a folding structure. Each of the plurality of bulkheads 61 having the folding structure is unfolded and greatly expanded, if the adjacent bulkhead that is in pressure equilibrium relation therewith is broken thus to reduce the pressure, such that the amount of buoyance lost can be restored considerably. In addition, when the floatation device is folded the inclined folding bulkheads 61 are folded and evenly distributed within the floatation device, such that the unbalance of the folded bulkheads 51 in a locally folded state of the simply partitioned floatation device 50 can be prevented. Each of the plurality of partitioned chambers of the functionally partitioned closed flotation device 60 is provided with an air pouring hole and a switch valve, to which an air supplying device is coupled, but an explanation of it will be excluded in the present description for the sake of brevity.

Another application example of the closed floatation device is shown in FIG. 10. As shown, there is provided a folding floatation device 70 with the front portion closed between a water blocking plate 6 on the front surface of the amphibious vehicle and an upper portion 7 (see FIG. 1) of the front surface of the amphibious vehicle, thereby providing additional buoyance to the front side of the amphibious vehicle and achieving improved safety.

By the way, since the upper portion 7 of the front surface of the amphibious vehicle is configured in such a manner as to be opened in order to check the state of a power apparatus installed in the amphibious vehicle, the folding floatation device 70 with the front portion closed is installed between the water blocking plate 6 with a double plate inside and outside on the front surface of the amphibious vehicle. Upon driving on the water, thereby, the inside water blocking plate 72 is fixed on the upper portion 7 of the front surface of the amphibious vehicle by means of fixing means (which is not shown) and only the outside water blocking plate 71 is unfolded, such that the floatation device 70 between the inside and outside water blocking plates 72 and 71 is unfolded. Upon checking the state of the amphibious vehicle on land, on the other hand, the floatation device 70 is not unfolded and the inside and outside water blocking plates 72 and 71 are fixed as a unitary body and then unfolded, thereby making the door on the upper portion of the front surface of the amphibious vehicle opened for the convenient checking.

The folding floatation device 70 with the front portion closed may be provided with the frames and elastic member like the above-mentioned floatation device 60 or may be comprised of only the inside and outside water blocking plates 72 and 71 and the outer cover. Of course, in this case, there is a need for installation of an air supplying and adjusting system, but an explanation of it will be excluded.

The forgoing embodiments are merely exemplary and are not to be construed as limiting the present invention. The present teachings can be readily applied to other types of devices. The description of the present invention is intended to be illustrative, and not to limit the scope of the claims. Many alternatives, modifications, and variations will be apparent to those skilled in the art.

In other words, since the floatation devices 10 to 70 according to the preferred embodiments of the present invention are folded when the amphibious vehicle is driven on land, thereby not giving any influence in driving and unfolded when it is driven on the water, thereby forming buoyance space therein, they are not limited to the above-described types of devices, and only if they exhibit the above-mentioned characteristics, they are contained in the technical contents of the present invention.

For example, the floatation device 10 according to the first embodiment of the present invention is not limited to the type of device with the buoyance space inclined according to the above-described structure in the first embodiment, but other kind of device where the sizes of left and right buoyance spaces are different when the amphibious vehicle is tilted to one side during driving on the water, thus to make the buoyance at the tilted side increased is contained in the scope of the present invention. To embody the above-mentioned other kind of device, a plurality of air holes are continuously formed on the lower portion of the hanging of the amphibious vehicle, or the hanging is cut partially and the sizes of buoyance are differently varied as the vehicle body is tilted.

As clearly discussed above, the floatation device according to the preferred embodiments of the present invention, which is configured in relatively simple manner, can provide improved additional buoyance to an amphibious vehicle when the amphibious vehicle is driven on the water, ensure an increased water driving speed of the amphibious vehicle and improve safety during driving on the water, thereby ensuring a high combat strength of the amphibious vehicle.

Additionally, the conventional amphibious vehicles are designed in such a manner that the weight thereof is under a predetermined level for the purpose of obtaining the buoyance enough to ensure the safety during driving on the water, thereby making it impossible to freely mount combat equipment on the amphibious vehicle, but the amphibious vehicle with the floatation device according to the present invention can mount the combat equipment corresponding to the additional buoyance, thereby resulting in the improvement of the combat strength.

What is claimed is:

1. A method for rendering a water driving speed of an amphibious vehicle increased, said method comprising the steps of:
disposing a housing structure, with connecting to a body and a side hanging of said amphibious vehicle, on the front and rear portions of left and right tracks, respectively, of said amphibious vehicle, thereby forming a buoyance space whose bottom surface is only opened by virtue of said structure, said body and said side hanging; and
pouring continuously air or gas to said buoyance space and forming and maintaining buoyance within said buoyance space when said amphibious vehicle is driven on the water, the upper portion of said track being located on said buoyance space.

2. The method as defined in claim 1, wherein said structure is adapted to be folded or unfolded so that if said amphibious vehicle is driven on land, said structure is folded and if driven on the water, said structure is unfolded, thereby continuously pouring air or gas to the space formed by an unfolding of said structure.

3. The method as defined in claim 1 or 2, wherein the lower end of said body of said amphibious vehicle and the lower end of said structure are disposed more below than the lower end of said side hanging to thereby form said buoyance space inclined obliquely, such that the safety in a rolling direction of said amphibious vehicle can be improved.

4. A device for providing additional buoyance to an amphibious vehicle to render a water driving speed of said amphibious vehicle increased, said device comprising:
a first plate frame being of an approximate shape of “ [symbol] ” and having fan-shaped both ends, said first plate adapted to be connected to a body of said amphibious vehicle and a side hanging on the front and rear portions of left and right tracks of said amphibious vehicle, respectively;
a plurality of second plate frames being folded to each other with the end portions coupled by means of a coupling member to said first plate frame, in such a manner as to be unfolded or folded in a fan shape and having a lowermost end disposed below to the upper portion of said track of said amphibious vehicle, when unfolded;
fixing means for folding and fixing said plurality of second plate frames when said amphibious vehicle is driven on land and for unfolding and fixing said plurality of second plate frames when said amphibious vehicle is driven on the water;
sealing means for providing tight sealing between said first plate frame and the second plate frame adjacent to said first plate frame and between said plurality of second plate frames, when said plurality of second plate frames are unfolded in order for said amphibious vehicle to be driven on the water; and
gas supplying means for continuously pouring air or gas into the space opened only at the bottom surface thereof at the time when said plurality of second plate frames are unfolded in order for said amphibious vehicle to be driven on the water.

5. A device for providing additional buoyance to an amphibious vehicle to render a water driving speed of said amphibious vehicle and safety in a rolling direction of said amphibious vehicle increased, said device comprising:
a track front housing for closing an opening formed on each front side of left and right track of said amphibious vehicle but further exposing the lower portion of the front side of each track than other sides thereof;
a track rear housing for closing an opening formed on each rear side of said left and right track of said amphibious vehicle but further exposing the lower portion of the rear side of each track than other sides thereof;
a tight plate structure cut in a shape of approximate “ [symbol] ” and having a center portion whose wings on the both sides thereof are cut, which takes a shape of a trapezoid, thereby rendering a side hanging of said amphibious vehicle inclined higher than a vehicle body;
a double rotary arm for placing said center portion of the trapezoid shape of said tight plate structure on the surfaces of said track front housing and said track rear housing, respectively and coupling said wings being cut on side walls of said track front housing and said track rear housing, respectively;
means for operating and fixing said double rotary arm such that said tight plate structure is placed on the upper portions of said track front housing and said track rear housing, respectively, when said amphibious vehicle is driven on land and said tight plate type structure is placed on the lower portions of said track front housing and said track rear housing, respectively, when said amphibious vehicle is driven on the water;
sealing means for tightly sealing the portion where said track front housing or said track rear housing and said tight plate structure are folded at the time when said tight plate type structure is placed on the lower portions of said track front housing and said track rear housing, respectively, in order for said amphibious vehicle to be driven on the water; and
air supplying means for continuously pouring air or gas into a buoyance space opened only at the bottom surface thereof that is formed by said track front housing, said track rear housing, said tight plate structure, said vehicle body and said side hanging at the time when said tight plate structure is placed on the lower portions of said track front housing and said track rear housing, respectively, in order for said amphibious vehicle to be driven on the water, whereby when said tight plat structure is placed on the lower portions of said track front housing and said track rear housing, respectively in order for said amphibious vehicle to be driven on the water, said wing cut coupled to said side hanging has the same height as said side hanging and said wing cut coupled to said vehicle body is inclined in the same height as the bottom surface of said vehicle body, thereby providing said buoyance space inclined.

6. A device for providing additional buoyance to an amphibious vehicle, said device comprising:
a fixed frame fixedly attached on a body of said amphibious vehicle;
an outermost frame of a shape of an appropriate “ [symbol] ” and rotatable centering around a coupling member coupled to the end portion of said fixed frame on the vehicle body;
a plurality of immediate frames coupled rotatably to said coupling member between said fixed frame on the vehicle body and said outermost frame and unfolded or folded in a fan shape when said outermost frame rotates;
an outer cover fixed on said fixed frame on the vehicle body and said outermost frame and fixed on the outside of said plurality of immediate frames such that it is unfolded or folded when said plurality of immediate frames are unfolded or folded;
an elastic member disposed between said fixed frame on the vehicle body, said plurality of immediate frames and said outermost frame such that said outer cover is folded regularly in a predetermined shape within a space between said outermost frame and said fixed frame on the vehicle body when said plurality of immediate frames are folded; and
means for unfolding or folding said outermost frame and fixing it.

7. The device as defined in claim 6, further comprising a fabric cover that is rolled on the top portion of the rear portion of the vehicle body, when said amphibious vehicle is driven on land and unrolled to cover the surface opened of said outermost frame, when said amphibious vehicle is driven on the water.

8. A device for providing additional buoyance to an amphibious vehicle, said device comprising:
a fixed frame fixedly attached on a body of said amphibious vehicle;
an outer plate adapted to be rotatable centering around a coupling member coupled to the end portion of said fixed frame on said vehicle body;
a plurality of immediate frames coupled rotatably to said coupling member between said fixed frame on said vehicle body and said outer plate and unfolded or folded in a fan shape when said outer plate rotates;
an outer cover fixed on said fixed frame on said vehicle body and said outer plate and fixed on the outside of said plurality of immediate frames such that it is unfolded or folded when said plurality of immediate frames are unfolded or folded; and
means for pouring air or gas into a closed buoyance space formed by said fixed frame on said vehicle body, said outer plate and said outer cover, thereby enabling said outer plate to be unfolded and for absorbing said air or gas from said closed buoyance space, thereby enabling said outer plate to be folded.

9. The device as defined in claim 8, further comprising a plurality of balloons disposed on the interior of said closed buoyance space formed by said fixed frame on the vehicle body, said outer plate and said outer cover and means for expanding a part or the whole of said plurality of balloons when said amphibious vehicle is driven on the water, a total allowable expansion volume of said plurality of balloons expanded higher than a maximum expansion volume of said closed buoyance space.

10. A device for providing additional buoyance to an amphibious vehicle, said device comprising:
an inside water blocking plate disposed on the front surface of said amphibious vehicle;
an outside water blocking plate rotatable centering around a coupling member coupled to an end portion of said inside water blocking plate;
an outer cover adapted to be fixed on said inside water blocking plate and said outside water blocking plate, thereby forming a closed buoyance space with said inside water blocking plate and said outside water blocking plate and adapted to be unfolded with said outside water blocking plate at the time of pouring air or gas into said closed buoyance space and folded with said outside water blocking plate at the time of absorbing said air or gas from said closed buoyance space;
means for unfolding or folding only said outside water blocking plate or said outside water blocking plate with said inside water blocking plate; and
means for fixing a position of said outside water blocking plate when said outside water blocking plate is unfolded.

11. A device for providing additional buoyance to an amphibious vehicle by attaching a closed buoyance space to the body of said amphibious vehicle, characterized in that a plurality of inclined pleated bulkheads are provided in said closed buoyance space so that said closed buoyance space can be divided into a plurality of slant subspaces.
